(19) United States
(12) Patent Application Publication
(10) Pub. No.: US 2025/0290350 A1
(43) Pub. Date: Sep. 18, 2025

(54) ELECTRIC LOCK AND TRANSMISSION MECHANISM THEREOF

(71) Applicant: TAIWAN FU HSING INDUSTRIAL CO., LTD., Kaohsiung City (TW)

(72) Inventors: Chao-Ming HUANG, Kaohsiung City (TW); Yi-Fang HUANG, Kaohsiung City (TW)

(21) Appl. No.: 19/071,506

(22) Filed: Mar. 5, 2025

(30) Foreign Application Priority Data
Mar. 13, 2024 (TW) 113109288

(51) Int. Cl. E05B 47/06; E05B 47/00

(52) U.S. Cl. CPC E05B 47/0657; E05B 47/0012; E05B 2047/0017; E05B 2047/0026

(57) ABSTRACT

An electric lock includes an internal lock assembly, an external lock assembly and a transmission mechanism. The internal lock assembly includes an internal casing and a motor arranged in the internal casing. The external lock assembly includes an external casing, an external handle rotatably mounted on the external casing, and a clutch mechanism arranged in the external casing. The transmission mechanism includes an internal transmission rod connected to a driving shaft of the motor, an external transmission rod connected to the clutch mechanism, and a spring connected between the internal transmission rod and the external transmission rod. When the motor rotates the driving shaft along a first rotating direction, the internal transmission rod is driven to rotate to further drive the external transmission rod to rotate through the spring, so as to drive the clutch mechanism to switch from a locking state to an unlocking state.

### BACKGROUND OF THE INVENTION

### 1. Field of the Invention

The present invention relates to an electric lock, and more particularly, to an electric lock with improved structure.

### 2. Description of the Prior Art

Generally, an electric lock has a motor and a clutch mechanism configured to control linkage between a handle and a latch. For example, when a user enters a correct password, the motor drives the clutch mechanism to link the handle to the latch, such that the latch can be moved when the handle is rotated; when the user enters an incorrect password, the motor does not drive the clutch mechanism to link the handle to the latch, such that the latch is not moved when the handle is rotated. However, when the motor drives the clutch mechanism to move, the clutch mechanism or related components of the electric lock may be damaged due to excessive rotation speed or torque of the motor. The electric lock of the prior art can not avoid the clutch mechanism or related components from being damaged due to the aforementioned situation.

### SUMMARY OF THE INVENTION

The present invention provides an electric lock and a transmission mechanism thereof.

An electric lock of the present invention comprises an internal lock assembly, an external lock assembly and a transmission mechanism. The internal lock assembly comprises an internal casing, and a motor arranged in the internal casing. The external lock assembly comprises an external casing, an external handle rotatably mounted on the external casing, and a clutch mechanism arranged in the external casing. The transmission mechanism comprises an internal transmission rod connected to a driving shaft of the motor, an external transmission rod connected to the clutch mechanism, and a spring connected between the internal transmission rod and the external transmission rod. When the motor rotates the driving shaft along a first rotating direction, the internal transmission rod is driven to rotate to further drive the external transmission rod to rotate through the spring, so as to drive the clutch mechanism to switch from a locking state to an unlocking state.

A transmission mechanism of an electric lock comprises an internal transmission rod connected to a driving shaft of a motor of the electric lock, an external transmission rod connected to a clutch mechanism of the electric lock, and a spring connected between the internal transmission rod and the external transmission rod. When the motor rotates the driving shaft, the internal transmission rod is driven to rotate to further drive the external transmission rod to rotate through the spring, so as to drive the clutch mechanism to switch between a locking state and an unlocking state.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an electric lock of the present invention;

FIG. 2 is a cross-sectional view of the electric lock of the present invention;

FIG. 3 is an exploded view of a first embodiment of a transmission mechanism of the electric lock of the present invention;

FIG. 4 is an exploded view of a clutch mechanism of the electric lock of the present invention.

FIG. 5 is a diagram showing the clutch mechanism of the electric lock of the present invention in a locking state.

FIG. 6 is a cross-sectional view of the clutch mechanism of the electric lock of the present invention in the locking state.

FIG. 7 is a diagram showing the clutch mechanism of the electric lock of the present invention in an unlocking state.

FIG. 8 is a cross-sectional view of the clutch mechanism of the electric lock of the present invention in the unlocking state.

FIG. 9 is an exploded view of a second embodiment of the transmission mechanism of the electric lock of the present invention.

FIG. 10 is a diagram showing the second embodiment of the transmission mechanism of the electric lock of the present invention in a transmission state.

FIG. 11 is a diagram showing the second embodiment of the transmission mechanism of the electric lock of the present invention in a protection state.

### DETAILED DESCRIPTION

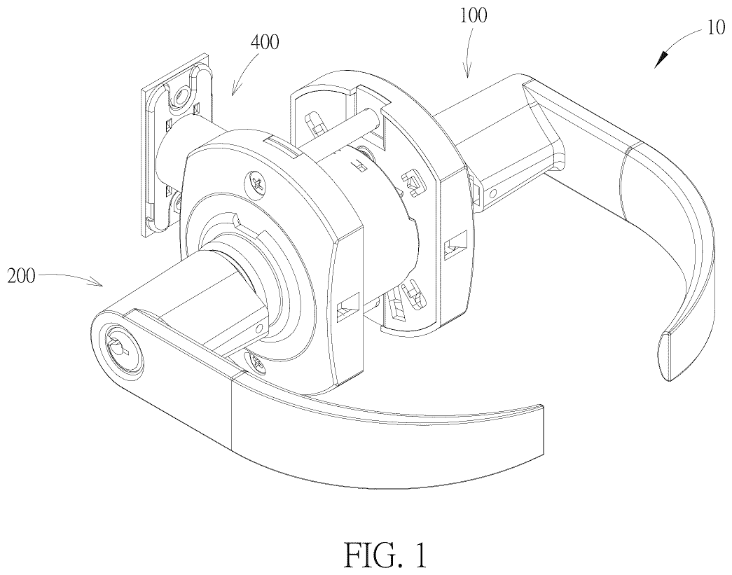

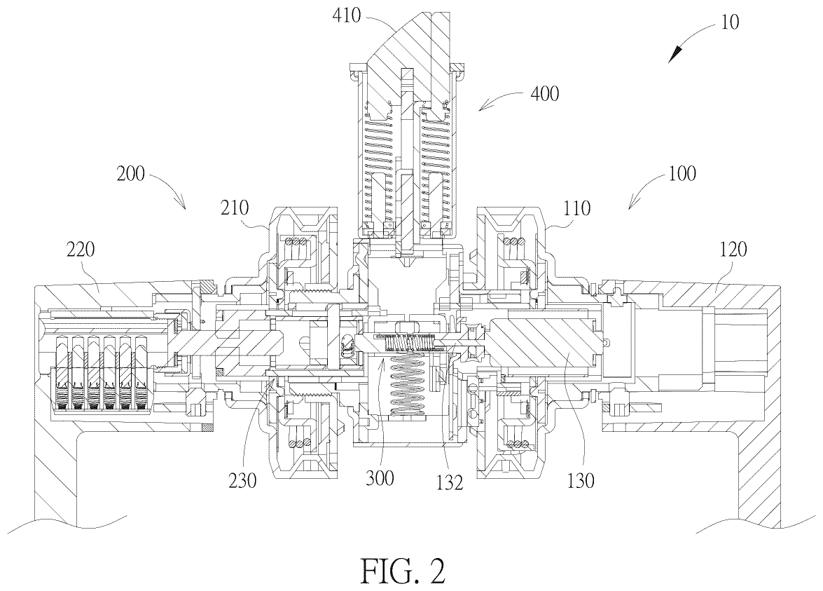

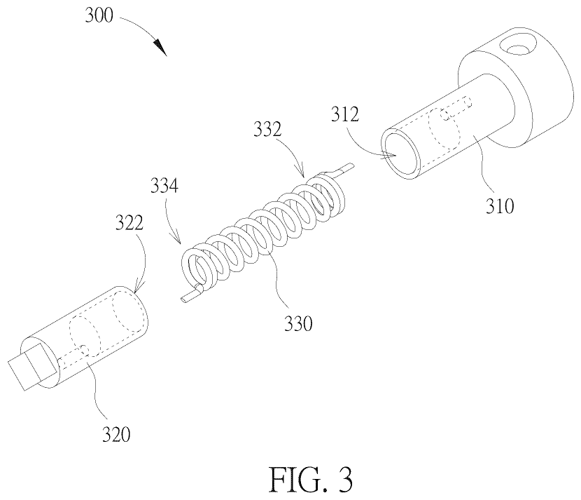

Please refer to FIG. 1 to FIG. 3. FIG. 1 is a diagram showing an electric lock of the present invention, FIG. 2 is a cross-sectional view of the electric lock of the present invention, and FIG. 3 is an exploded view of a first embodiment of a transmission mechanism of the electric lock of the present invention. As shown in the figures, the electric lock 10 of the present invention comprises an internal lock assembly 100, an external lock assembly 200, a transmission mechanism 300 and a latch assembly 400. The internal lock assembly 100 comprises an internal casing 110, an internal handle 120 and a motor 130. The internal handle 120 is rotatably mounted on the internal casing 110. The motor 130 is arranged in the internal casing 110, and has a driving shaft 132. The external lock assembly 200 comprises an external casing 210, an external handle 220, and a clutch mechanism 230. The external handle 220 is rotatably mounted on the external casing 210. The clutch mechanism 230 is arranged in the external casing 210. The transmission mechanism 300 comprises an internal transmission rod 310, an external transmission rod 320, and a spring 330. The internal transmission rod 310 is connected to the driving shaft 132 of the motor 130. Then external transmission rod 320 is connected to the clutch mechanism 230. The spring 330 is connected between the internal transmission rod 310 and the external transmission rod 320. When the motor 130 rotates the driving shaft 132, the internal transmission rod 310 is driven to rotate to further drive the external transmission rod 320 to rotate through the spring 330, so as to drive the clutch mechanism 230 to switch between a locking state and an unlocking state.

In the first embodiment of the transmission mechanism 300 of the electric lock 10 of the present invention, the spring 330 has a first end part 332 fixedly connected to the internal transmission rod 310, and a second end part 334 fixedly connected to the external transmission rod 320. The internal transmission rod 310 is formed with a first accommodation recess 312 configured to accommodate the first end part 332 of the spring 330. The external transmission rod 320 is formed with a second accommodation recess 322 configured to accommodate the second end part 334 of the spring 330.

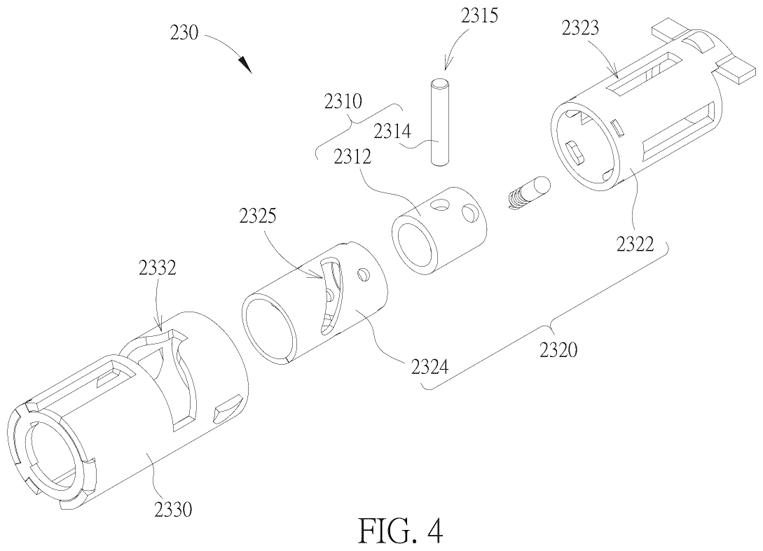

Please refer to FIG. 4. FIG. 4 is an exploded view of the clutch mechanism of the electric lock of the present invention. As shown in FIG. 4, the clutch mechanism comprises a clutch module 2310, a driving module 2320, and a connecting base 2330. The clutch module 2310 comprises a sliding piece 2312 and a clutch rod 2314. The driving module 2320 comprises a guiding base 2322 and a driving base 2324. The sliding piece 2312 is slidably arranged in the driving base 2324. The clutch rod 2314 is arranged on the sliding piece 2312. The guiding base 2322 has a guiding structure 2323, and the driving base 2324 has a driving structure. The clutch rod 2314 has a first clutch structure 2315 (one end of the clutch rod 2314) configured to penetrate through the guiding structure 2323 and the driving structure 2325. The connecting base 2330 has a second clutch structure 2332 corresponding to the first clutch structure 2315. The driving base 2324 is connected to the external transmission rod 320 and configured to be driven by the external transmission rod 320 to rotate relative to the guiding base 2322 and the connecting base 2330.

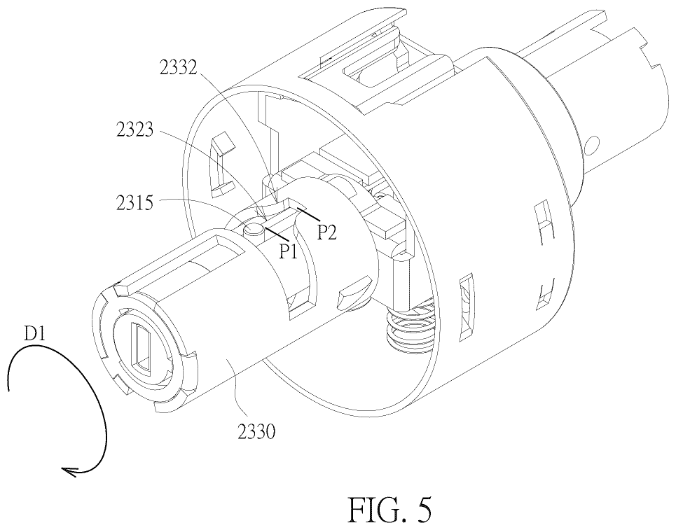

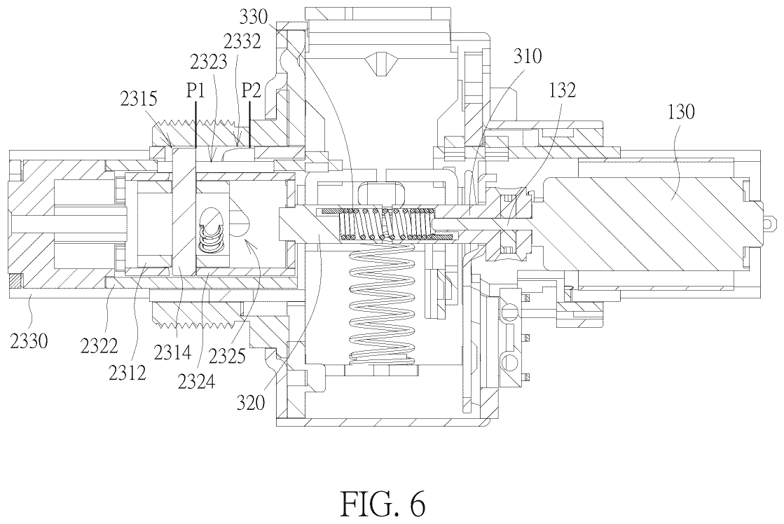

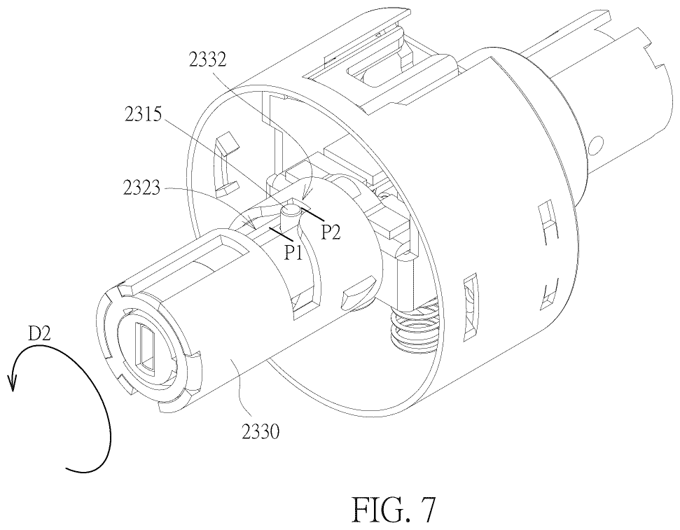

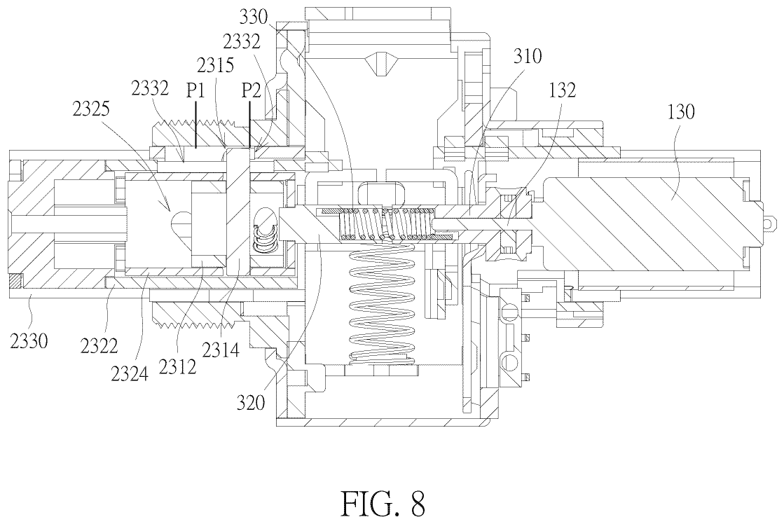

Please refer to FIG. 5 to FIG. 8, and refer to FIG. 1 to FIG. 4 as well. FIG. 5 is a diagram showing the clutch mechanism of the electric lock of the present invention in the locking state, FIG. 6 is a cross-sectional view of the clutch mechanism of the electric lock of the present invention in the locking state, FIG. 7 is a diagram showing the clutch mechanism of the electric lock of the present invention in the unlocking state, and FIG. 8 is a cross-sectional view of the clutch mechanism of the electric lock of the present invention in the unlocking state. When the clutch mechanism 230 of the electric lock 10 of the present invention is in the locking state, the first clutch structure 2315 of the clutch module 2310 is located at a first position P1 relative to the second clutch structure 2332 of the connecting base 2330 (as shown in FIG. 5 and FIG. 6). As such, the first clutch structure 2315 of the clutch module 2310 is not engaged with the second clutch structure 2332 of the connecting base 2330. When the clutch mechanism 230 is in the locking state and when the motor 130 rotates the driving shaft 132 along a first rotating direction D1, the internal transmission rod 310 is driven to rotate to further drive the external transmission rod 320 to rotate through the spring 330. When the external transmission rod 320 is rotated along the first rotating direction D1 to further drive the driving base 2324 to rotate relative to the guiding base 2322, the first clutch structure 2315 of the clutch rod 2314 is driven by the driving structure 2325 of the driving base 2324 to move from the first position P1 to a second position P2 along the guiding structure 2323 of the guiding base 2322.

When the first clutch structure 2315 of the clutch rod 2314 is driven by the driving structure 2325 of the driving base 2324 to move from the first position P1 to the second position P2 along the guiding structure 2323 of the guiding base 2322 (as shown in FIG. 7 and FIG. 8), the first clutch structure 2315 of the clutch module 2310 is engaged with the second clutch structure 2332 of the connecting base 2330. As such, the clutch mechanism 230 of the electric lock 10 of the present invention is in the unlocking state. When the clutch mechanism 230 is in the unlocking state and when the external handle 220 is rotated, the external handle 220 is configured to rotate the connecting base 2330, so as to drive the first clutch structure 2315 to rotate to further drive the guiding base 2322 to rotate, in order to drive a latch 410 (as shown in FIG. 2) of the latch assembly 400 of the electric lock 10 to move to an unlocking position.

On the other hand, when the clutch mechanism 230 is in the unlocking state and when the motor 130 rotates the drive shaft 132 along a second rotating direction D2 (opposite to the first rotating direction D1), the external transmission rod 320 is rotated along the second rotating direction D2 to drive the driving base 2324 to rotate relative to the guiding base 2322, and the first clutch structure 2315 of the clutch rod 2314 is driven by the driving structure 2325 of the driving base 2324 to move from the second position P2 to the first position P1 along the guiding structure 2323 of the guiding base 2322. As such, the clutch mechanism 230 returns to the locking state.

According to the above arrangement, the transmission mechanism 300 of the present invention utilizes the spring 330 to transmit power of the motor 130 from the internal transmission rod 310 to the external transmission rod 320. When torque or rotation speed of the driving shaft 132 of the motor 130 is over a certain level, the spring 330 is configured to accumulate excess torque in order to prevent the clutch mechanism 230 or other related components from being damaged. In addition, the internal transmission rod 310 and the external transmission rod 320 of the transmission mechanism 300 of the present invention are designed to be cylindrical so as to limit the spring 330 within the first accommodation recess 312 and the second accommodation recess 322, thereby preventing the spring 330 from being damaged due to excessive deformation when the spring 330 accumulates the excess torque.

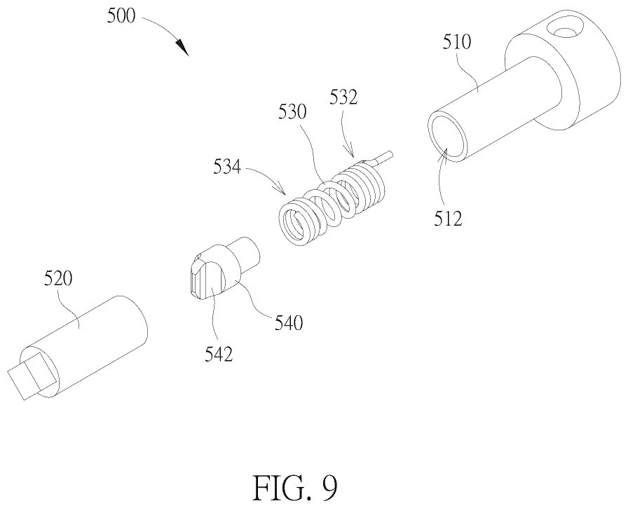

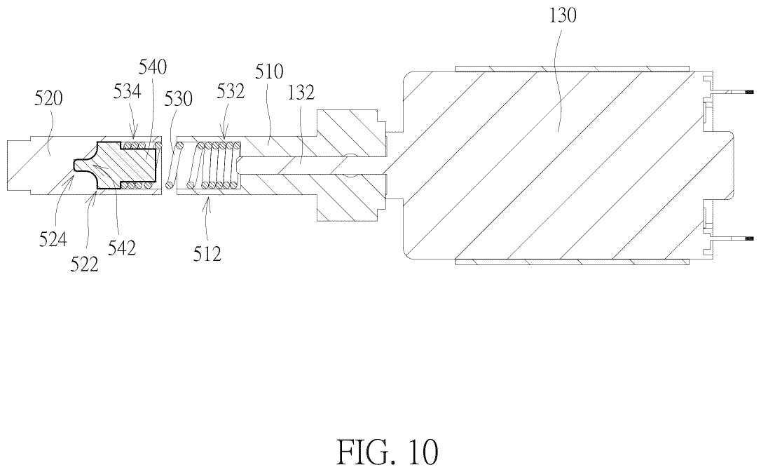

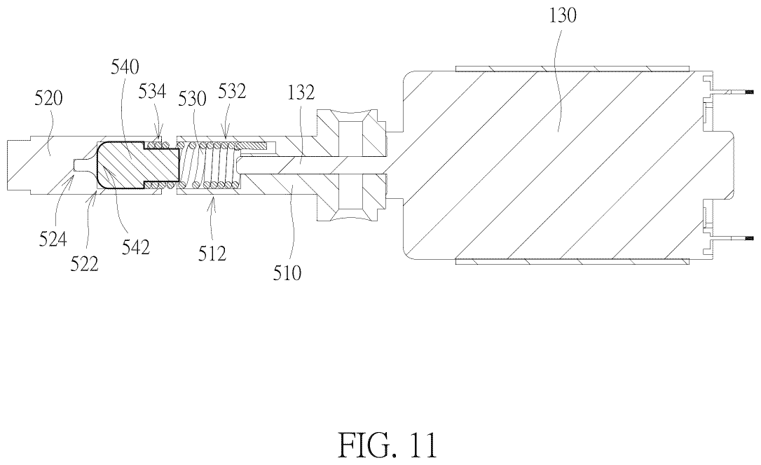

Please refer to FIG. 9 to FIG. 11. FIG. 9 is an exploded view of a second embodiment of the transmission mechanism of the electric lock of the present invention, FIG. 10 is a diagram showing the second embodiment of the transmission mechanism of the electric lock of the present invention in a transmission state, and FIG. 11 is a diagram showing the second embodiment of the transmission mechanism of the electric lock of the present invention in a protection state. As shown in the figures, in the second embodiment of the transmission mechanism 500 of the electric lock of the present invention, the transmission mechanism 500 comprises an internal transmission rod 510, an external transmission rod 520, a spring 530, and an engaging shaft 540. The spring 530 has a first end part 532 fixedly connected to the internal transmission rod 510, and a second end part 534 fixedly connected to the engaging shaft 540. The internal transmission rod 510 is formed with a first accommodation recess 512 configured to accommodate the first end part 532 of the spring 530. The external transmission rod 520 is formed with a second accommodation recess 522 configured to accommodate the engaging shaft 540 and the second end part 534 of the spring 530. In addition, the external transmission rod 520 is formed with an engaging structure 524 in the second accommodation recess 522. A shape of a front end 542 of the engaging shaft 540 corresponds to the engaging structure 524, such that the engaging shaft 540 is configured to be engaged with the engaging structure 524. In the present embodiment, the engaging structure 524 has an arc surface, but the present invention is not limited thereto.

As shown in FIG. 10, when the transmission mechanism 500 is in the transmission state, the engaging shaft 540 is engaged with the engaging structure 524 of the external transmission rod 520. As such, when the motor 130 rotates the driving shaft 132, the internal transmission rod 510 is driven to rotate to further drive the engaging shaft 540 and the external transmission rod 520 to rotate together through the spring 530, so as to drive the clutch mechanism 230 to switch between the locking state and the unlocking state.

When the torque of the driving shaft 132 of the motor 130 is greater than a predetermined value with the related components of the clutch mechanism 230 reaching predetermined positions and cannot be moved or rotated further (or when the rotation speed of the driving shaft 132 of the motor 130 is higher than a predetermined rotation speed), the front end 542 of the engaging shaft 540 is configured to rotate relative to the arc surface of the engaging structure 524 to be moved backward, such that the engaging shaft 540 is disengaged from the engaging structure 524 of the external transmission rod 520 (as shown in FIG. 11). In other words, when the torque of the driving shaft 132 of the motor 130 is greater than a predetermined value (or the rotation speed is higher than the predetermined rotation speed), the transmission mechanism 500 is configured to be in a protection state. When the transmission mechanism 500 is in the protection state, the external transmission rod 520 is not rotated with the driving shaft 132 of the motor 130 (the engaging shaft 540 is configured to rotate relative to the external transmission rod 520 to be repeatedly engaged with and disengaged from the engaging structure 524 of the external transmission rod 520) in order to protect the clutch mechanism 230 or other related components from being damaged. In addition, when the torque or the rotation speed of the driving shaft 132 of the motor 130 returns to a normal level, the front end 542 of the engaging shaft 540 is configured to be engaged with the engaging structure 524 of the external transmission rod 520 again, such that the transmission mechanism 500 returns to the transmission state.

In the embodiments of the electric lock of the present invention, the structural configuration of the clutch mechanism 230 is only an example, and the present invention is not limited thereto. The transmission mechanism 300, 500 of the electric lock of the present invention can also work with other types of clutch mechanisms. On the other hand, the driving shaft of the motor 130 is directly connected to the internal transmission rods 310, 510 of the transmission mechanism 300, 500, but the present invention is not limited thereto. In other embodiments of the electric lock of the present invention, the driving shaft of the motor 130 can be connected to the internal transmission rod 310, 510 of the transmission mechanism 300, 500 through other mechanisms (such as a gear mechanism).

In contrast to the prior art, the transmission mechanism 300, 500 of the present invention utilizes the spring 330, 530 to transmit power of the motor 130 from the internal transmission rod 310, 510 to the external transmission rod 320, 520, in order to prevent the clutch mechanism 230 or other related components from being damaged due to excessive torque or rotation speed of the motor. In addition, the internal transmission rod 310, 510 and the external transmission rod 320, 520 of the transmission mechanism 300, 500 of the present invention are designed to be cylindrical so as to limit the spring 330, 530 within the first accommodation recess 312, 512 and the second accommodation recess 322, 522, thereby preventing the spring 330, 530 from being damaged due to excessive deformation when the spring 330, 530 accumulates the excess torque. Moreover, when the transmission mechanism 300, 500 of the present invention is in the protection state, the engaging shaft 540 is configured to be disengaged from the engaging structure 524 of the external transmission rod 520, in order to further protect the clutch mechanism 230 or other related components from damage. Therefore, the electric lock of the present invention has higher reliability.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electric lock, comprising:
an internal lock assembly, comprising:
an internal casing; and
a motor arranged in the internal casing;
an external lock assembly, comprising:
an external casing;
an external handle rotatably mounted on the external casing; and
a clutch mechanism arranged in the external casing;
a transmission mechanism, comprising:
an internal transmission rod connected to a driving shaft of the motor;
an external transmission rod connected to the clutch mechanism; and
a spring connected between the internal transmission rod and the external transmission rod;
wherein when the motor rotates the driving shaft along a first rotating direction, the internal transmission rod is driven to rotate to further drive the external transmission rod to rotate through the spring, so as to drive the clutch mechanism to switch from a locking state to an unlocking state.

2. The electric lock of claim 1, wherein when the motor rotates the driving shaft along a second rotating direction, the internal transmission rod is driven to rotate to further drive the external transmission rod to rotate through the spring, so as to drive the clutch mechanism to switch from the unlocking state to the locking state; wherein the second rotating direction is opposite to the first rotating direction.

3. The electric lock of claim 1, wherein the spring has a first end part fixedly connected to the internal transmission rod, and a second end part fixedly connected to the external transmission rod.

4. The electric lock of claim 3, wherein the internal transmission rod is formed with a first accommodation recess configured to accommodate the first end part of the spring, and the external transmission rod is formed with a second accommodation recess configured to accommodate the second end part of the spring.

5. The electric lock of claim 1, wherein the external transmission rod is formed with an engaging structure, the transmission mechanism further comprises an engaging shaft configured to be engaged with the engaging structure; wherein the spring has a first end part fixedly connected to the internal transmission rod, and a second end part fixedly connected to the engaging shaft.

6. The electric lock of claim 5, wherein the internal transmission rod is formed with a first accommodation recess configured to accommodate the first end part of the spring, and the external transmission rod is formed with a second accommodation recess configured to accommodate the engaging shaft and the second end part of the spring.

7. The electric lock of claim 5, wherein when torque of the driving shaft is greater than a predetermined value, the engaging shaft is configured to be disengaged from the engaging structure.

8. The electric lock of claim 1, wherein the clutch mechanism comprises:
a clutch module having a first clutch structure;
a driving module connected to the external transmission rod and configured to drive the clutch module to move between a first position and a second position when the external transmission rod is rotated; and
a connecting base having a second clutch structure;
wherein when the clutch module is located at the second position, the first clutch structure of the clutch module is engaged with the second clutch structure of the connecting base, such that the clutch mechanism is in the unlocking state;
wherein when the clutch mechanism is in the unlocking state and when the external handle is rotated, the external handle is configured to drive the first clutch structure of the clutch module to rotate through the connecting base, in order to further drive a latch of the electric lock to move.

9. The electric lock of claim 8, wherein when the clutch module is located at the first position, the first clutch structure of the clutch module is not engaged with the second clutch structure of the connecting base, such that the clutch mechanism is in the locking state.

10. The electric lock of claim 8, wherein the driving module comprises:
a guiding base having a guiding structure; and
a driving base having a driving structure, wherein the driving base is connected to the external transmission rod and configured to be driven by the external transmission rod to rotate relative to the guiding base;
wherein the clutch module comprises:
a sliding piece slidably arranged in the driving base; and
a clutch rod arranged on the sliding piece and having the first clutch structure penetrating through the guiding structure and the driving structure;
wherein when the external transmission rod drives the driving base to rotate relative to the guiding base, the first clutch structure of the clutch rod is driven by the driving structure to move between the first position and the second position along the guiding structure.

11. A transmission mechanism of an electric lock, comprising:
an internal transmission rod connected to a driving shaft of a motor of the electric lock;
an external transmission rod connected to a clutch mechanism of the electric lock; and
a spring connected between the internal transmission rod and the external transmission rod;
wherein when the motor rotates the driving shaft, the internal transmission rod is driven to rotate to further drive the external transmission rod to rotate through the spring, so as to drive the clutch mechanism to switch between a locking state and an unlocking state.

12. The transmission mechanism of claim 11, wherein the spring has a first end part fixedly connected to the internal transmission rod, and a second end part fixedly connected to the external transmission rod.

13. The transmission mechanism of claim 12, wherein the internal transmission rod is formed with a first accommodation recess configured to accommodate the first end part of the spring, and the external transmission rod is formed with a second accommodation recess configured to accommodate the second end part of the spring.

14. The transmission mechanism of claim 11, wherein the external transmission rod is formed with an engaging structure, the transmission mechanism further comprises an engaging shaft configured to be engaged with the engaging structure; wherein the spring has a first end part fixedly connected to the internal transmission rod, and a second end part fixedly connected to the engaging shaft.

15. The transmission mechanism of claim 14, wherein the internal transmission rod is formed with a first accommodation recess configured to accommodate the first end part of the spring, and the external transmission rod is formed with a second accommodation recess configured to accommodate the engaging shaft and the second end part of the spring.

16. The transmission mechanism of claim 14, wherein when torque of the driving shaft is greater than a predetermined value, the engaging shaft is configured to be disengaged from the engaging structure.
